(19) United States
(12) Patent Application Publication
(10) Pub. No.: US 2007/0081207 A1
(43) Pub. Date: Apr. 12, 2007

(54) Method and arrangement for combining holograms with computer graphics

(75) Inventor: Oliver Bimber, Weimar (DE)

Correspondence Address: JORDAN AND HAMBURG LLP, 122 EAST 42ND STREET, SUITE 4000, NEW YORK, NY, 10168, US

(73) Assignee: Bauhaus-Universitaet Weimar, Weimar (DE)

(21) Appl. No.: 10/577,289

(22) PCT Filed: Sep. 30, 2004
(86) PCT No.: PCT/DE04/02171

§ 371 Date: Apr. 27, 2006

(30) Foreign Application Priority Data
Oct. 27, 2003 (DE) 10350223.8
Dec. 3, 2003 (DE) 10356434.9

(51) Int. Cl. G03H 1/08

(52) U.S. Cl. 359/9

(57) ABSTRACT

The aim of the invention is to provide a method and an arrangement for carrying out said method, by which means optical holograms and interactive computer graphics can be harmoniously and uniformly combined, so that all components can be recognised in an optically sharp and separate manner and the holograms can be represented in a modified manner, especially also partially accentuated. According to the invention, the hologram is illuminated by an illumination image projected by the video projector, a holographic wave front that can be seen by the observer is reconstructed therefrom, and computer graphics are simultaneously displayed on the screen. The invention also relates to a method for combining computer graphics with an optical hologram having a virtual content, using a partially transparent, optical element, a hologram, a monitor located on the side of the partially transparent element opposing the observer, and a video projector, the 3D holographic image of the hologram superimposing the image of the monitor.

### BACKGROUND OF THE INVENTION

The invention relates to a method for combining an optical hologram having a virtual content with computer graphics by using a semi-transparent optical element, a hologram, a monitor on an optical element side which is pointing away from an observer, and a video projector, wherein the holographic image of the hologram appears overlayed with the picture of the monitor.

The invention is preferably used for presenting computer-generated information in holograms, in particular for emphasizing hologram details.

A hologram is a photometric emulsion carrying interference patterns of coherent light. In contrast to simple photographs it stores not only amplitude and wavelength information, but also the phase information of incident light rays, i.e. origin and direction, respectively. It can thereby reconstruct a complete optical wavefront, making visible a three-dimensional image of the recorded content.

Optical holograms are static, an interaction with the observer is impossible. In multiplex holograms built from multiple narrow vertical-strip holograms that contain recordings of the same scene from different times or positions, the observer can perceive the recorded scene in motion when moving relatively to the hologram.

Combining three-dimensional computer graphics with stereoscopic presentation techniques provides an alternative that allows interactivity. Recent rendering methods on recent graphics hardware can produce interactive, realistic images. However, they do not even approximately approach the quality and realism of holographic images.

Autostereoscopic displays allow for observing computer-generated scenes without special glasses. There are different autostereoscopic techniques to present several perspective views of objects at one time, thus supporting multiple observers simultaneously. Resolution and rendering speed, however, decrease with the number of views generated. Holographic images, in contrast, can reproduce all depth cues, the perspective, the binocular appearance, the motion parallax, the convergence, and the accommodation and can simultaneously reach a theoretically unlimited number of observers.

There are efforts to use computer-generated holograms. Presently, they can be separated into two categories: On the one hand, digital holography using holographic/optical printers to create a normal hologram in the emulsion from a scene rendered in a computer. The multiplexing method is possible thereby, but interaction is not. On the other hand, the development of electroholography aims to create holograms by means of computers and to present the holographic images in realtime. After different methods for computing the interference patterns or stereograms they are visualized using a holographic display comprising, for example, a liquid crystal or acoustic-optical space light modulators. Because of the enormous amounts of data that have to be processed, transmitted, and stored, the method is limited by the present computer technology. The limit expresses in such a way that in spite of advanced reduction and compression methods only small interactive electroholograms can be created. Besides, they have low resolution and color depth.

Optical holograms can store and restore large amounts of information in a thin holographic emulsion almost without loss of quality. Resolutions of less than 3 μm are possible. Until this quality can be achieved with other methods by increasing the computing power, a combination of interactive computer graphics and optical high-quality holograms would be a desirable alternative.

The U.S. Pat. No. 5,109,289 describes a method for highlighting a selected area of a holographic image by brightening and/or magnifying the area by means of a repositionable lens in the optical illumination path.

Disadvantageously, the highlighting can only be performed by brightening or magnifying; no additional information is presentable within the hologram; and using one lens only one respective area can be highlighted.

From WO 96/35975 an arrangement for displaying an image of an object is known, comprising an optical system for creating the image, a semi-transparent mirror and a presentation arrangement in the background, wherein an observer sees the image and the background presentation overlayed through the mirror. The optical system can comprise a holographic film in such a way that the holographic image appears in front of the mirror. The background presentation can be a computer monitor with moving pictures.

This arrangement has several disadvantages. The computer monitor is provided for moving pictures only, not for static pictures. The pictures can only appear two-dimensionally flat and unconditionally interpenetrate the holographic image. The appearance of the holographic image is immutable, in particular no parts can be emphasized or modified. A controlled illumination is impossible. Furthermore, the perspective of the observer is not considered, leading to perspective misrepresentation. Besides, the arrangement needs a space-consuming mechanical construction, because a certain angle has to be preserved between the monitor and the mirror (e.g. 45°).

It is an object of this invention to specify a method and an arrangement for performing the method, by which optical holograms and interactive computer graphics can be combined harmonically and consistently in such a way that all parts are optically sharp and perceivable separately and that the holograms can be displayed in a modified way, in particular partially emphasized.

### SUMMARY OF THE INVENTION

Method and apparatus are provided according to the invention. The apparatus includes a display, an optical hologram arranged between as observer and the display and having a virtual content and also included in the apparatus are computer graphics content, a semi-transparent optical element interposed between the hologram and the display and a video projector for projecting an illumination image by means of the projector. Thereby, according to the method of the invention, a holographic wavefront visible to the observer is reconstructed and, simultaneously therewith, rendered computer graphics rendered from the computer graphics content is displayed on the display.

Other features of the invention are described hereinbelow.

Combining optical holograms with graphical 2D or 3D elements provides an acceptable tradeoff between quality and interactivity. While the holographic content provides high-quality content, but stays static, the additional graphical information be generated, inserted, modified and animated at interactive rates, and can also be high-quality within their standards. For overlaying both components optical combiners such as mirror beam splitters or semi-transparent mirrors are used behind the hologram emulsion. In case of transmission holograms a very compact construction is possible this way.

In case of opaque reflection holograms additional optical combination elements are required to overlay the images. However, the approach is basically the same.

Thereby it is possible to use digital holograms as well as electroholograms.

New reflection holograms that can be produced without a darkening layer make it possible to omit a semi-transparent optical element, because they work as such a one themselves by letting pass and reflecting light. They also allow for presenting a vertical parallax, in contrast to conventional transmission holograms which can only reproduce a horizontal parallax.

Thus, all white light holograms can be used: transmission and reflection holograms and among them monochrome and color holograms, respectively. A real color representation is possible, too, in particular using multiple hologram layers back-to-back.

Usual video projectors are light sources that are able to create an intensive and also spectrally very uniform light by their high-power discharge lamps (HDI lamps). These are very advantageous preconditions for illuminating holograms. As they are point light sources able to emit light selectively to different directions, wherein all projection segments or directions are separately addressable, i.e. illuminatable, they are very advantageous for a potentially variable illumination.

By a reconstruction of the wavefront in parts only, which is possible dynamically, and/or by modifying the amplitudes of the elements of the holographic image from the hologram by selectively illuminating the hologram, advantageously the holographic image can be manipulated.

By displaying the computer graphics in zones of the emulsion that are not illuminated, i.e. that are not reconstructed, the overlay of computer graphics and holographic image is clearly separated, so that the light from both components does not mutually interpenetrate nor superimpose, respectively. Both components are clearly perceptible thereby.

By using multiple buffers for calculating the computer graphics and the illumination image the computations can be performed as fast as possible. Thereby, a Z buffer, a stencil buffer and a frame buffer are used, wherein the buffers are also applied for determining Boolean expressions. Advantageously, the computations are performed by a 3D computation unit (GPU).

By modifying the amplitude of the wavefront the illumination situation within the holographic image can be modified, in particular to emphasize hologram details optically, to attenuate or to mask out nonrelevant parts, or to adjust the illumination on the hologram to the illumination on the computer graphics.

For this purpose, advantageously the old illumination situation is excluded from an illumination image that has already been computed and the new illumination situation is incorporated.

As all applied rendering techniques are supported by hardware acceleration of conventional graphics adapters, interactive frame rates are achieved without problems.

By an autostereoscopic presentation of the computer graphics in combination with appropriate display arrangements, in particular a lenticular lens sheet display, the holographic and the computer-generated image content appear three-dimensionally in the same space.

By using a detection facility for the head position and/or eye position, in particular a head-finder, the required observer position can be continually adjusted to the actual situation.

By arranging a protection layer in front of the hologram, on the one hand, a plane shape is ensured and, on the other hand, the risk of damages is significantly reduced.

In the following, the invention is explained in further detail using examples of embodiments.

### BRIEF DESCRIPTION OF THE DRAWINGS

It is shown by:

FIG. 1 an exploded view of an arrangement in accordance with the invention except of the projector,

FIG. 2 a schematic depiction of a cross section of an arrangement in accordance with the invention,

FIG. 3 a flowchart of an algorithm for illumination image and computer graphics,

FIG. 4 a flowchart of an alternative, simplified algorithm,

FIG. 5 a schematic depiction for modifying the illumination,

FIGS. 6 and 7 schematic depictions of results of the method according to the invention.

### DETAILED DESCRIPTION OF THE INVENTION

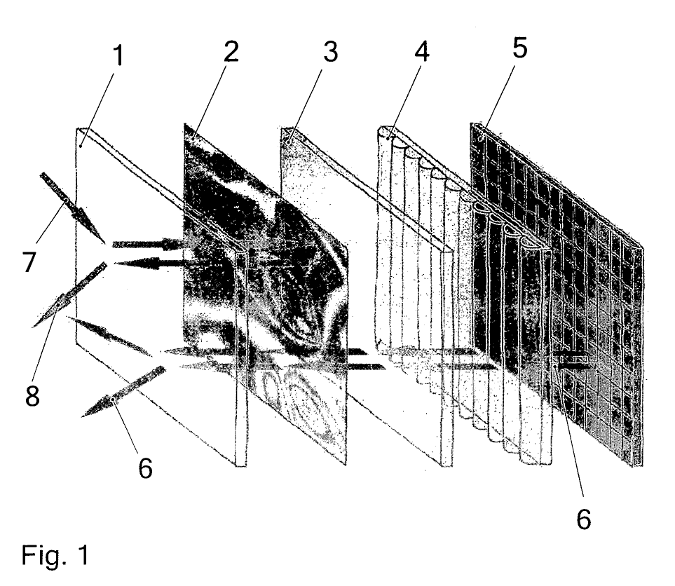

FIG. 1 shows an example of how a transmission hologram can be effectively combined with a lenticular lens sheet 4 in front of an LCD display 5. This is a variation of a parallax display that utilizes the refraction of a lens array 4 to direct light 6 to different observer areas. By placing the holographic emulsion 2 in front of a mirror beam splitter 3 it can be illuminated from the front by incident light 7 and can be augmented with graphics R from behind, the graphics R emitting light 6. A thin glass plate 1 protects the emulsion 2 from damages.

The lenticular lens sheet 4 redirects the light 6 emitted from the LCD array 5 through the first three layers 1, 2 and 3 towards the eyes of an observer V. The light 7 projected by a video projector P is transmitted through the first two layers 1 and 2 and is partially reflected by the beam splitter 3. The holographic image is reconstructed by the wavefront arising in the emulsion 2 and striking the eyes of the observer V as the escaping light 8.

If a transparent reflection hologram, i.e. without a darkening layer, is used instead of a transmission hologram the semi-transparent mirror is not necessary. The hologram itself acts like such a one then.

Instead of an LCD monitor arbitrary indication instruments that are able to display computer graphics can be applied. Flat screen displays are especially suitable because of their space-saving construction.

The method in accordance with the invention of course works with active or passive stereoscopic presentation instead of autostereoscopic presentation, too. Also, a monoscopic presentation is possible. As, presently, there are no large autostereoscopic displays available it is necessary to switch to stereoscopic projection displays in order to further scale the size, which is without difficulty though.

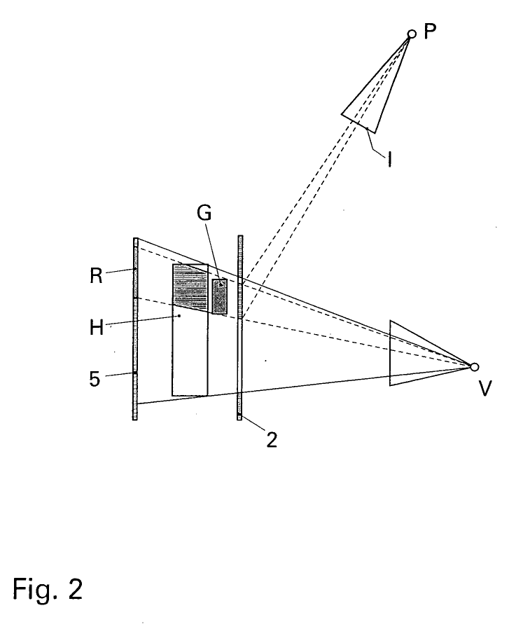

In FIG. 2 it is schematically shown how the selective illumination on the holographic plate 2 is performed by the video projector P projecting the illumination image I thereonto. If the emulsion 2 is closely attached to the display 5 both can be considered to be identical. The geometric area, in which the display 5 displays the rendered computer graphics R, is not illuminated. In this area in the holographic image, the observer V sees the graphics R without overlay with possibly existing content H of the hologram. The contents H and G of the hologram and the computer graphics, respectively, are purely virtual. They do not become visible until the wavefront is reconstructed from the emulsion 2 and the rendered graphics R is displayed on the display 5, respectively.

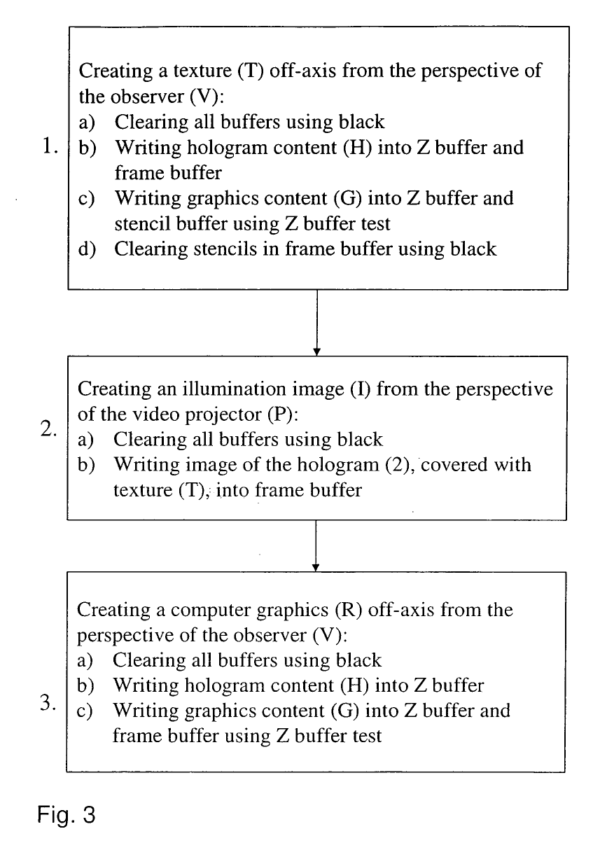

An algorithm for computing the illumination image I and the graphics R using conventional graphics hardware is depicted in FIG. 3. The depth information in the form of the content H of the hologram 2 und the scene description of the content G of the computer graphic are assumed to be known. Reasonably, both are suitably aligned. Practically, this will be performed outside of normal operation. Cameras can be used to perform an automatic alignment if optical markers are recorded when recording the the hologram. The intrinsic and extrinsic parameters of the projector P with respect to the holographic emulsion 2 also have to be known. The required quantities are reasonably determined in a calibration outside of the normal operation.

The algorithm takes into account the three-dimensional situation of both the hologram content H and the graphics content G. It results in a correct presentation of the whole image even if both contents virtually interpenetrate, as only such parts of the graphics' content G become visible that are located in front of the hologram content H from the perspective of the observer V. In the corresponding zones of the illumination image I black areas are produced, so the emulsion 2 is not illuminated there. Generally, the hologram 2 is only illuminated in zones where content H exists. Thereby, no undesired light reflection can occur in zones where no hologram content H is visible at all.

First, as an intermediate stage a texture image T is created off-axis from the observer V across the emulsion 2 by rendering the hologram content H into a Z buffer and a frame buffer using the defined light color and intensity. Subsequently, the graphics content G is rendered into the Z buffer and a stencil buffer using a Z buffer test. The stencil areas are cleared in the frame buffer using black. The illumination image I is rendered on-axis from the projector P after all buffers have been cleared, by writing an image of the emulsion 2 that is covered with the texture T into the frame buffer. The illumination image I is cast onto the holographic emulsion by the video projector P.

The graphics image R that is to be displayed on the display 5 is rendered off-axis from the observer V by writing the hologram content H in to the Z buffer after clearing all buffers and writing the graphics content G into Z buffer and frame buffer using a Z buffer test.

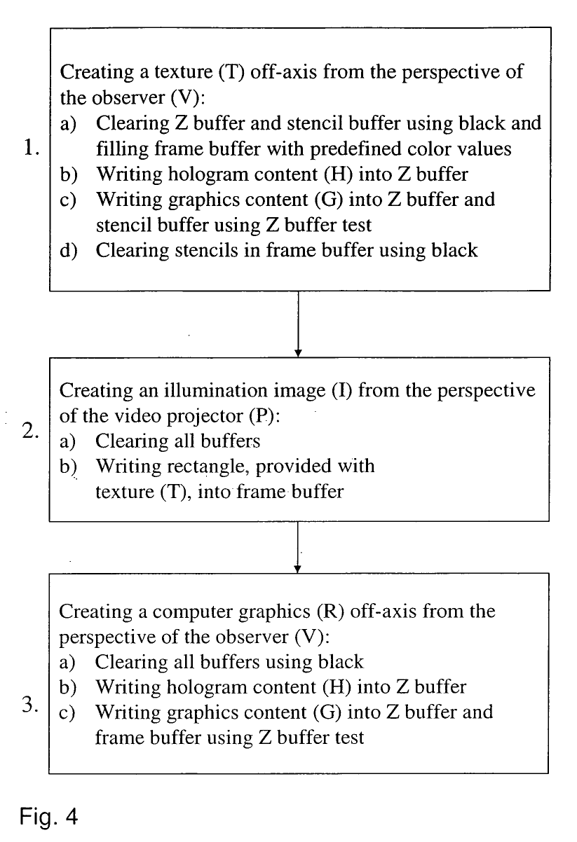

An alternative, simplified algorithm is shown by FIG. 4. It works basically the same way as the algorithm described above, but irradiates the hologram 2 using predetermined color values except for the zones of graphics R, in particular using white light of maximal intensity.

Besides of a partial reconstruction of a hologram, i.e. either fully illuminated or not at all, variations of the projected light allow for locally modifying the amplitude of the wavefront. Practically, this means that, in step 1.b) of the first algorithm above, where the hologram content H is written to the Z buffer and to the frame buffer, shading and shadow-mapping techniques are used instead of rendering the hologram content H with a uniform intensity only.

For this purpose, first the physical shading effects caused by the real light sources during hologram recording must be neutralized. Next, the effects of virtual light sources can be added, for example.

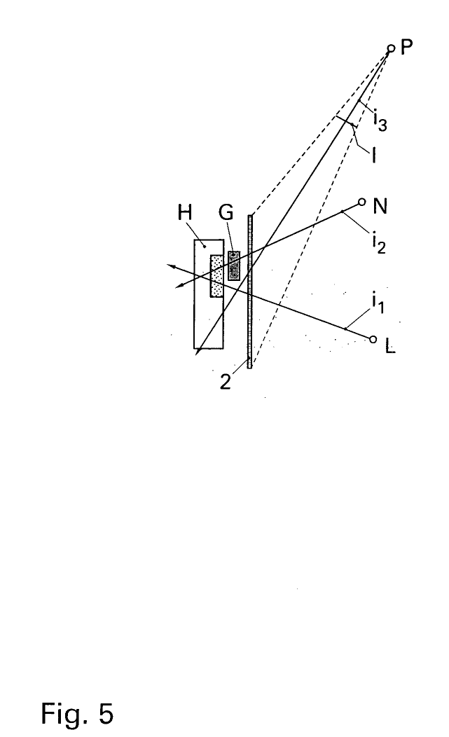

This manipulation can also be performed using conventional graphics hardware by rendering two images of the hologram content H from the perspective of the projector P, wherein a diffuse white material is used for the whole content H in both images. FIG. 5 shows a schematic representation on this. For the first image i₁ virtual light sources L are defined that approximately create the same shading effects as the real light sources during the hologram recording process. For the second image i₂ virtual light sources are defined that represent the new synthetic illumination situation. In both images known hardware accelerated shading techniques can be used for creating synthetic shadows on the hologram content H, resulting from the virtual light sources because of the graphics content G and also the hologram content H itself. A third image i₃ is created by rendering the hologram emulsion 2 from the perspective of the projector P using a diffuse white material and a point light source located at the position of the projector P. This intensity image i₃ represents the geometric relationship between the video projector P, being a physical point light source, and the hologrpahic emulsion 2. It contains form factors like the square-distance attenuation and the angular dependency of the intensity of the light projected onto the hologram 2.

The final illumination image I is computed using the relation I=i₂/i₁/i₃, for example in realtime using pixelshaders. This neutralizes the physical shadings of the hologram recording as much as possible and creates the new shadings and shadows. Again, the graphical content R is cut out using the stencil buffer.

Also, shadows cast onto the graphics content G by the hologram content H can be created using known shading and shadow-mapping techniques during the rendering of the graphics content G into the frame buffer in the last step of the algorithm described above.

In order to design the computations to be as realistic as possible, advantageously a detection facility for the position of the observer V is used, e.g. a head-finder, so that the eyes' position of the observer V is known with a defined error.

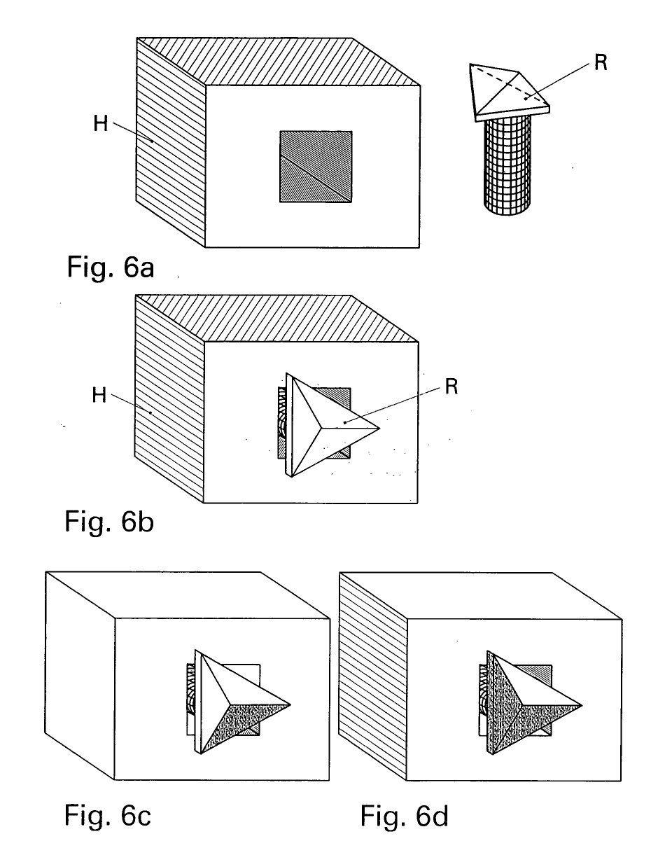

In FIG. 6 the effect of the method is illustrated with simple geometric bodies which are located besides each other in sub-figure a). The cuboid, having a recess, represents the holographic image of the hologram content H. During the hologram recording it was illuminated from the bottom right. The cylinder having a pyramid-like attachment represents die computer graphics R rendered from the virtual graphics content G. In a) it has been rendered with uniform brightness. In sub-figure b) the virtual position and orientation of the graphics' content was modified in such a way that the cylinder appears within the recess of the cuboid. Because of the algorithm in accordance with the invention the display 5 does only show those parts of the graphics content G that would be visible in front of, besides or through the hologram content. Simultaneously the hologram 2 is illuminated in such a way that those parts that would lie behind the graphics content G in a real arrangement are dark, so that only the computer graphics R is visible there. Two completely different pictures are realistically merged this way. In the sub-figures c) and d) the algorithm for manipulating the illumination is illustrated. The original illumination situation of the hologram content H has been neutralized and has been replaced by a virtual new illumination situation from top left in sub-figure c) and from top right in sub-figure d).

There are many possible applications for the invention. Archaeologists, for example, already use optical holograms to archive and investigate ancient artifacts. Scientists can use hologram copies to perform their research without having to access the original artifacts or inaccurate replicas. Combining these holograms with interactive computer graphics allows them to integrate real-time simulation data or perform experiments that require direct user interaction, such as reconstructing soft tissue in a fossilized dinosaur skull hologram. In addition, specialized interaction devices can simulate haptic feedback of holographic and computer-graphical content while performing these interactive tasks by observing and analyzing the positions and/or movements of fingers and/or of other extremeties and by triggering appropriate actions.

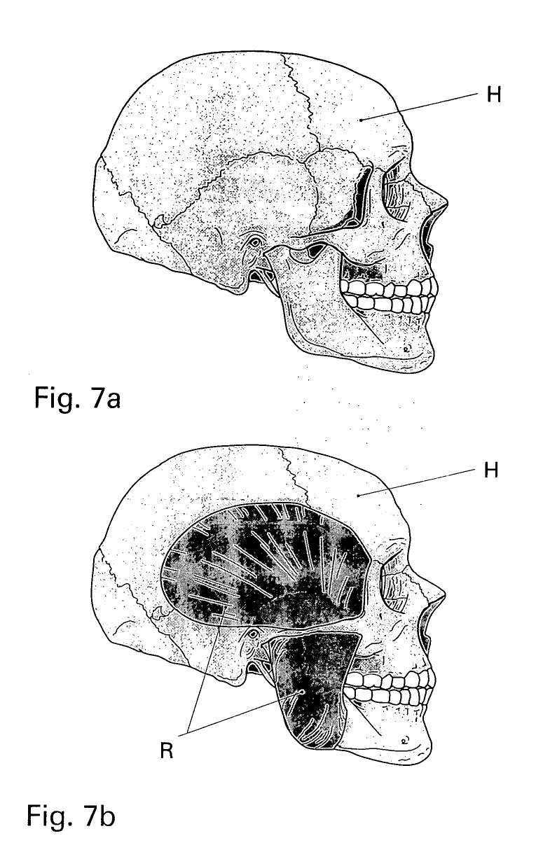

In FIG. 7 a) the holographic image of a human skull is schematically shown. In sub-figure b) the skull has been realistically provided with chewing muscles by means of the method according to the invention. In the area of the zygomatic bone the actually contiguous muscle graphics' content G is not rendered, because the zygomatic bone, as a part of the hologram's content H, is recognized during the algorithm to be lying in front of the graphic's content G because of its depth information.

An entire collection of artifacts will fit into a single album of holographic recordings. A display device similar to a light-box can be used for visualization and interaction.

Optical holograms in museums can be augmented with animated multimedia content. This opens up the possibilty to present information about the exhibition samples in a more attractive and effective way than simple text labels offer. Such displays can interact with the user. Wall-mounted variations require little space, whereby museums can display a larger number of exhibition samples. Clearly, holograms or other replicas cannot substitute for original exhibits, because viewing those originals is the main reason to visit a museum. If, however, a unique exhibit is unavailable or too fragile to be displayed, holograms still offer the possibility to present its three-dimensional image and to create an interactive experience in combination with computer graphics.

If the method according to the invention is used different display variations can be developed. For example in case of transmission holograms, with only modifiying the mirror arbitrary shapes such as cylinders for multiplex holograms can be supported instead of simple planar plates 1, 2, 4 and/or 5 only. Even without a graphical augmentation, projector-based illumination alone offers many possibilities. In combination with optical holograms, also with digital or electroholograms, it can be used to create visual effects. Certain zones of a hologram, for example, can be made temporarily invisible while others can be temporarily or permanently emphasized. In another example, transmission holograms comprising several layers can be activated using separate light projections by reconstructing under different angles. Thereby, simple animation effects similar to multiplex holograms are supported without the observer being required to move with respect to the hologram or the hologram being required to move.

The described techniques can also be used for non-planar constructions and holograms, respectively. For this purpose, merely the projection techniques of the rendering methods have to be slightly modified. Instead of projecting the texture onto a plane, i.e. the holography plate as used in the algorithms, one has to project onto an appropriate arbitrary geometry. As to the rendering technique this is performed by covering an arbitrary geometry by the generated texture as a projective texture. This projective texture-mapping is supported by any 3D graphics adapter in hardware. The correct texture coordinates are computed automatically.

By combining several displays 5 and/or several holograms 2 large dimensions can be achieved using cost-efficient, small components.

List of Reference Numerals

1 Protection layer

2 Hologram/Holographic emulsion

3 Mirror beam splitter

4 Lenticular lens sheet

5 LCD display

6 Light from the LCD display

7 Incident light of the video projector

8 Reflected light of the video projector

P Video projector

V Observer

H Virtual hologram content

G Virtual graphics content

R Rendered computer graphics

1. (canceled)

2. The method according to claim 22, wherein, by means of the image projected by the projector, modifying amplitude of portions of the wavefront.

3. The method according to claim 2, wherein parts of the holographic image are emphasized.

4. The method according to claim 22 or 2, wherein, by means of the image projected by the projector, the wavefront is partially reconstructed.

5. The method according to claim 2 or 3, wherein the computer graphics content is arranged in areas of the hologram content that are not reconstructed or are only partially reconstructed.

6. The method according to claim 5, comprising, for computing the illumination image and the rendered computer graphics, providing a Z buffer, a stencil buffer and a frame buffer;
creating a texture off-axis from the perspective of the observer by
a) clearing all buffers using black,
b) writing the hologram content into the Z buffer and the frame buffer,
c) writing the graphics content into the Z buffer and the stencil buffer using a Z buffer test,
d) clearing the stencils in the frame buffer using black;
creating the illumination image from the perspective of the video projector by
a) clearing all buffers using black,
b) writing the image of the hologram, provided with the texture, into the frame buffer; and
creating the rendered computer graphic off-axis from the perspective of the observer by
a) clearing all buffers using black,
b) writing the hologram content into the Z buffer,
c) writing the graphics content into the Z buffer and the frame buffer using a Z buffer test.

7. The method according to claim 5, comprising, for computing the illumination image and the rendered computer graphics, providing a Z buffer, a stencil buffer and a frame buffer,
creating a texture off-axis from the perspective of the observer (V) by
a) clearing the Z buffer and the stencil buffer using black and filling the frame buffer with predefined color values,
b) writing the hologram content into the Z buffer,
c) writing the graphics content into the Z buffer and the stencil buffer using a Z buffer test,
d) clearing the stencils in the frame buffer using black;
creating the illumination image from the perspective of the video projector by
a) clearing all buffers using black,
b) writing the image of a white rectangle, provided with the texture, into the frame buffer; and
creating the rendered computer graphic off-axis from the perspective of the observer by
a) clearing all buffers using black,
b) writing the hologram content into the Z buffer,
c) writing the graphics content into the Z buffer and the frame buffer using a Z buffer test.

8. The method according to claim 22, wherein by means of the illumination image of the video projector, amplitude of the wavefront is modified and the illumination state of the holographic image is modified.

9. The method according to claim 8, wherein first an original illumination state is computationally neutralized and then a new illumination image is computed using a new illumination state.

10. The method according to claim 9, wherein the new illumination image is computed by
computing two projections of the hologram content from the perspective of the video projector, wherein diffuse white material is used for the hologram content and shading and/or shadow-mapping computations are performed,
a) the first projection is created using virtual light sources causing approximately the same shadings on the hologram content as the original light sources during hologram recording,
b) the second projection is created using virtual light sources causing the desired new illlumination situation; and
computing a third projection of the hologram from the perspective of the video projector, wherein diffuse, white material is used for the hologramm and the projector comprises a point light source and
computing the ratio of the ratios of the second and the first projection and the third projection.

11. The method according to claim 8, 9 or 10, wherein the light effects in the rendered computer graphic correspond to the modified illumination state of the wavefront.

12. The method according to claim 22 or 2, further comprising providing a detection device and by means thereof measuring the head and/or eye position of the observer and incorporating the measurement into the computation of the computer graphics and/or of the illumination image of the video projector.

13. The method according to claim 22 or 2, further comprising providing an optically transparent layer and protecting and/or stabilizing the hologram by means of the optically transparent layer.

14. The method according to claim 22 or 2, wherein the rendered computer graphics is created stereoscopically, autostereoscopically or monoscopically.

15. The method according to claim 22 or 2, further comprising providing a lenticular lens sheet between the observer and the display and wherein the rendered computer graphics is created stereoscopically and appears to be three-dimensional to the observer through the lenticular lens sheet.

16. (canceled)

17. The apparatus according to claim 23, further comprising a lenticular lens sheet arranged between the display and the semi-transparent element.

18. The apparatus according to claim 23 or 17, further comprising a detection device for detecting head and/or eye position of the observer.

19. The apparatus according to claim 18, wherein the detection device comprises a head-finder.

20. The apparatus according to claim 23 or 17, further comprising an optically transparent layer arranged at the hologram.

21. The arrangement according to claim 23 or 17, wherein the hologram is a reflection hologram without darkening layer and is itself the semi-transparent element.

22. A method for combining an optical hologram having a virtual content with computer graphics content thereby to produce an image in a display in which a holographic image of the hologram appears overlayed with the computer graphics, comprising providing a display, providing an optical hologram arranged between an observer and the display and having a virtual content, providing computer graphics content, providing a semi-transparent optical element interposed between the hologram and the display, providing a video projector for projecting an illumination image, illuminating the hologram by projecting an illumination image by means of the projector, reconstructing a holographic wavefront visible to the observer and, simultaneously therewith, displaying on the display rendered computer graphics rendered from the computer graphics content.

23. Apparatus for combining an optical hologram having a virtual content with computer graphics content, comprising a display for displaying rendered computer graphics, an optical hologram arranged between an observer and the display, a semi-transparent optical element interposed between the hologram and the display and a video projector for illuminating the hologram by means of an illuminating image.
